(19) United States
(12) Patent Application Publication
(10) Pub. No.: US 2025/0061726 A1
(43) Pub. Date: Feb. 20, 2025

(54) OBSTACLE DETECTION FOR TRAILER TURNS

(71) Applicant: Robert Bosch GmbH, Stuttgart (DE)

(72) Inventor: Srivathsan Sridharan Iyengar, Canton, MI (US)

(21) Appl. No.: 18/803,056

(22) Filed: Aug. 13, 2024

Related U.S. Application Data
(60) Provisional application No. 63/520,016, filed on Aug. 16, 2023.

(51) Int. Cl. G06V 20/58; B60Q 9/00; G06T 7/73

(52) U.S. Cl. CPC G06V 20/58; B60Q 9/008; G06T 7/73; G06T 2207/30261

(57) ABSTRACT

A device may include a camera positioned at a rear of the vehicle, the camera configured to capture images of the trailer and a scene including an object, the camera further configured to generate image data corresponding to the scene and output the image data. A device may include a controller on the vehicle, the controller including an input/output interface, a memory, and an electronic processor configured to: receive the image data from the camera, analyze the object in the scene, calculate the position of the trailer and the object relative to one another, determine that the object is an obstacle using an obstacle detection algorithm, and determine that the obstacle has exceeded a proximity threshold, wherein in response to the determination that the obstacle has exceeded the proximity threshold, the controller controls the vehicle.

### RELATED APPLICATIONS

This application claims the benefit of U.S. Provisional Patent Application No. 63/520,016, filed Aug. 16, 2023, the entire content of which is hereby incorporated by reference.

### FIELD

Embodiments described herein relate to a system of obstacle detection for a trailer.

### SUMMARY

Many vehicles include radar systems for detecting and monitoring vehicle blind spots. Additionally, many vehicles include trailer hauling capabilities. The radar capabilities of a vehicle do not always cover the additional blind spots introduced by the trailer. It may be desirable for the vehicle include additional augmented details regarding these blind spots. Therefore, embodiments described herein provide, among other things, systems and methods for detecting vehicle blind spots.

In some aspects, the techniques described herein relate to a system of obstacle detection for a trailer connected to and towed by a vehicle, the system including: a camera positioned at a rear of the vehicle, the camera configured to capture images of the trailer and a scene including an object, the camera further configured to generate image data corresponding to the scene and output the image data; a controller on the vehicle, the controller including an input/output interface, a memory, and an electronic processor configured to: receive the image data from the camera, analyze the object in the scene, calculate the position of the trailer and the object relative to one another, determine that the object is an obstacle using an obstacle detection algorithm, and determine that the obstacle has exceeded a proximity threshold, wherein in response to the determination that the obstacle has exceeded the proximity threshold, the controller controls the vehicle.

In some aspects, the techniques described herein relate to a system, wherein the electronic processor further analyzes the image data to determine object data points and background data points. In some aspects, the techniques described herein relate to a system, wherein the electronic processor determines that the object is an obstacle based upon the object data points and determines that the object is not an obstacle based upon the background data points. In some aspects, the techniques described herein relate to a system, wherein the electronic processor further calculates a 3D position of the trailer, an instantaneous articulation angle of the trailer, and a position of the object relative to the position of the trailer.

In some aspects, the techniques described herein relate to a system, wherein the proximity threshold is a distance of less than 1 meter, and wherein in response to the determination that the obstacle has exceeded the proximity threshold, the controller stops the vehicle. In some aspects, the techniques described herein relate to a system, wherein the electronic processor further calculates an instantaneous articulation angle of a plurality of corners of the trailer relative to the object. In some aspects, the techniques described herein relate to a system, wherein the proximity threshold is a range of distance between the object and the trailer, the range of distance including between 5 centimeters and 1 meter.

In some aspects, the techniques described herein relate to a system, wherein the electronic processor further determines that the obstacle has exceeded a first proximity threshold and a second proximity threshold, the second proximity threshold being a closer proximity between the trailer and the obstacle, wherein in response to the obstacle exceeding the first proximity threshold, the controller generates an alert, and wherein in response to the obstacle exceeding the second proximity threshold, the controller controls the vehicle.

In some aspects, the techniques described herein relate to a system, wherein the obstacle detection algorithm includes producing a coordinate plot of the image data including object data points and background data points.

In some aspects, the techniques described herein relate to a method of obstacle detection for a trailer connected to and towed by a vehicle, the method including: generating, by a camera positioned at a rear of the vehicle, images of the trailer and a scene including an object, outputting, by the camera, image data corresponding to the scene, receiving, by an electronic processor, the image data analyzing, by the electronic processor, the object in the scene, calculating, by the electronic processor, the position of the trailer and the object relative to one another, determining, by the electronic processor, that the object is an obstacle using an obstacle detection algorithm, determining, by the electronic processor, that the obstacle has exceeded a proximity threshold, and wherein response to the determination that the obstacle has exceeded the proximity threshold, controlling, by the electronic processor, the vehicle.

In some aspects, the techniques described herein relate to a method, the method further including analyzing, by the electronic processor, the image data to determine object data points and background data points. In some aspects, the techniques described herein relate to a method, the method further including calculating, by the electronic processor, an instantaneous articulation angle of a plurality of corners of the trailer relative to the object.

In some aspects, the techniques described herein relate to a method, the method further including calculating, by the electronic processor, a range of distance between the object and the trailer, the range of distance including between 5 centimeters and 1 meter.

In some aspects, the techniques described herein relate to a method, the method further including: determining, by the electronic processor, that the obstacle has exceeded a first proximity threshold and a second proximity threshold, the second proximity threshold being a closer proximity between the trailer and the obstacle, generating, by the electronic processor, an alert in response to the obstacle exceeding the first proximity threshold, and controlling, by the electronic processor, the vehicle in response to the obstacle exceeding the second proximity threshold.

In some aspects, the techniques described herein relate to a method, the method further including generating by the electronic processor, a coordinate plot of the image data including object data points and background data points.

In some aspects, the techniques described herein relate to a system of obstacle detection for a trailer connected to and towed by a vehicle, the system including: a camera positioned at a rear of the vehicle, the camera configured to capture images of the trailer and a scene including an object, the camera further configured to generate image data corresponding to the scene and output the image data; a controller on the vehicle, the controller including an input/output interface, a memory, and an electronic processor configured to: receive the image data from the camera, generate object data points and background data points from the image data, generate a coordinate plot of the image data including object data points and background data points, calculate a position of a plurality of corners of the trailer using the object data points and background data points, calculate an instantaneous articulation angle of the plurality of corners of the trailer relative to the object, calculate a 3D position of the trailer relative to the object using the instantaneous articulation angle, determine that the object is an obstacle using an obstacle detection algorithm, and determine that the obstacle has exceeded a first proximity threshold and a second proximity threshold, the second proximity threshold being a closer proximity between the trailer and the obstacle, wherein in response to the obstacle exceeding the first proximity threshold, the controller generates an alert, and wherein in response to the obstacle exceeding the second proximity threshold, the controller controls the vehicle.

In some aspects, the techniques described herein relate to a system, wherein the electronic processor determines that the object is an obstacle based upon the object data points and determines that the object is not an obstacle based upon the background data points. In some aspects, the techniques described herein relate to a system, wherein the electronic processor further calculates the instantaneous articulation angle of the corners of the trailer relative to the object based upon dimensions of the trailer and the position of the corners of the trailer.

In some aspects, the techniques described herein relate to a system, wherein the first proximity threshold is a range of distance between the object and the trailer, the range of distance including between 5 centimeters and 1 meter but greater than the second proximity threshold, and wherein the second proximity threshold is a range of distance between the object and the trailer, the range of distance including between 5 centimeters and 1 meter but less than the first proximity threshold.

In some aspects, the techniques described herein relate to a system, wherein response to the determination that the obstacle has exceeded the first proximity threshold, the controller generates an alert for a driver of the vehicle, the alert indicating that the trailer and the obstacle are in danger of colliding, and wherein response to the determination that the obstacle has exceeded the second proximity threshold, the controller stops the vehicle.

Other aspects, features, and embodiments will become apparent by consideration of the detailed description and accompanying drawings.

### BRIEF DESCRIPTION OF THE DRAWINGS

FIG. 1 illustration of a system of obstacle detection for trailer turns, according to some aspects.

FIG. 2 is an image of the system of FIG. 1, according to some aspects.

FIG. 3 is a block diagram illustration of the system of FIG. 1, according to some aspects.

FIG. 4 is a graph of objects detected by the system obstacle detection for trailer turns, according to some aspects.

FIG. 5 is a flowchart of a process for obstacle detection for trailer turns, according to some aspects.

### DETAILED DESCRIPTION

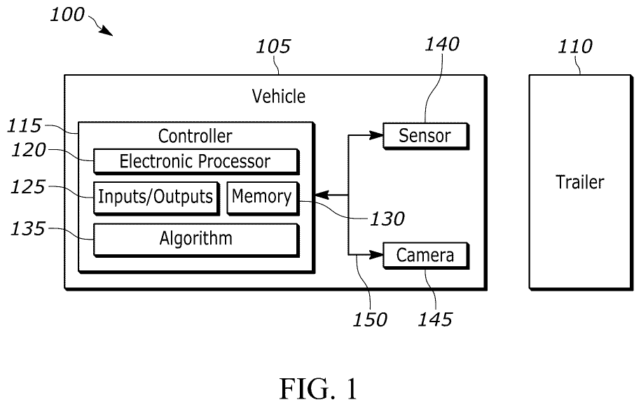

FIG. 1 is an illustration of a system of obstacle detection for trailer turns, according to some aspects. System 100 includes a vehicle 105 and a trailer 110 attached to the vehicle 105 by a hitch. The vehicle 105 has an onboard a controller 115. In the illustrated example, the controller 115 includes an electronic processor 120, an input/output interface 125, and memory 130. In some examples, electronic processor 120 is implemented as a microprocessor with separate memory, for example the memory 130. In other examples, the electronic processor 120 may be implemented as a microcontroller (with memory 130 on the same chip). In other examples, the electronic processor 120 may be implemented using multiple processors. In addition, the electronic processor 120 may be implemented partially or entirely as, for example, a field-programmable gate array (FPGA), an applications specific integrated circuit (ASIC), and the like and the memory 130 may not be needed or be modified accordingly.

In some examples, the memory 130 includes non-transitory, computer-readable memory that stores instructions that are received and executed by the electronic processor 120 to carry out method described herein including methods of road surface detection. The memory 130 may include, for example, a program storage area and a data storage area. The program storage area and the data storage area may include combinations of different types of memory, for example read-only memory and random-access memory. The input/output interface 125 may include one or more input mechanisms and one or more output mechanisms (for example, general-purpose input/outputs (GPIOs), a controller area network bus (CAN) bus interface, analog inputs digital inputs, and the like).

Stored within memory 130 is software used during operation of the vehicle 105. For instance, an obstacle detection algorithm 135 (also referred to as algorithm 135) may be stored within memory 130 or in a separate memory location. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

The vehicle 105 also includes a sensor 140. Sensor 140 may be a speed sensor, an accelerometer, a radar sensor, a LIDAR sensor, or the like. The vehicle 105 also includes a camera 145 configured to capture images of the trailer 110 connected to the vehicle 105. For example, in one embodiment, the camera is mounted on the rear of the vehicle, near the trailer hitch, and is angled downward to capture a wide view of the area behind the vehicle. A vehicle CAN bus 150 electronically and communicatively connects the camera 145, sensor 140, and vehicle controller 115 to each other.

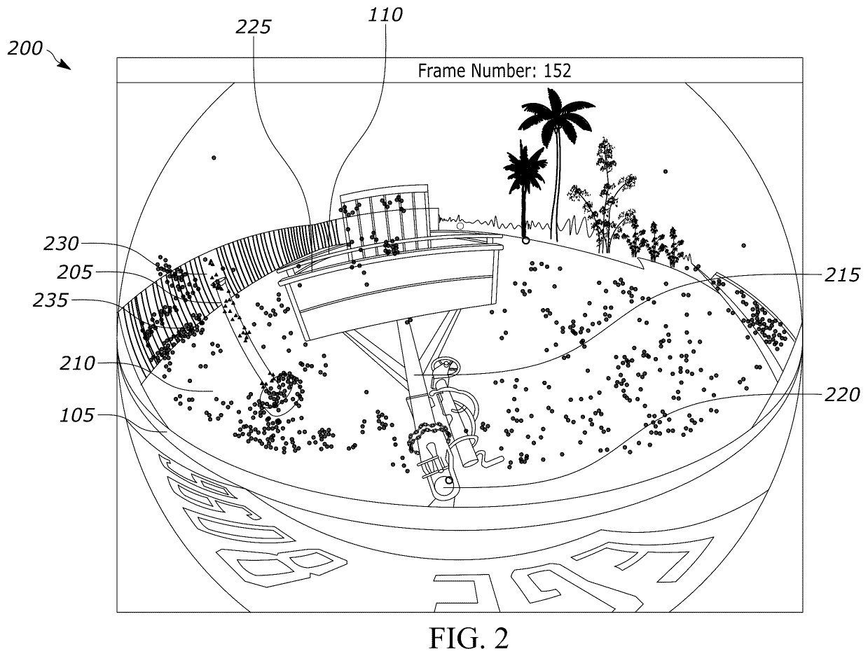

FIG. 2 is an image 200 from the camera 145 connected to the vehicle 105. As previously described, the camera 145 angled downward to capture a wide view of the area. Also shown in the image 200 is the trailer 110, an obstacle 205, the road surface 210, a trailer chassis 215, a vehicle hitch 220, and a corner of the trailer 225. The size of the trailer, including the position of the corner of the trailer 225 relative to the trailer chassis 215 and vehicle hitch 220, are later used by the algorithm 135. The camera records images 200 and saves the image data to the controller 115, where the obstacle detection algorithm 135 analyzes the image data using structure from motion techniques to determine precise obstacle 205 position relative to the trailer 110. Objects detected by the camera may include fences, cones, curbs, other vehicles, road surfaces, or any other object.

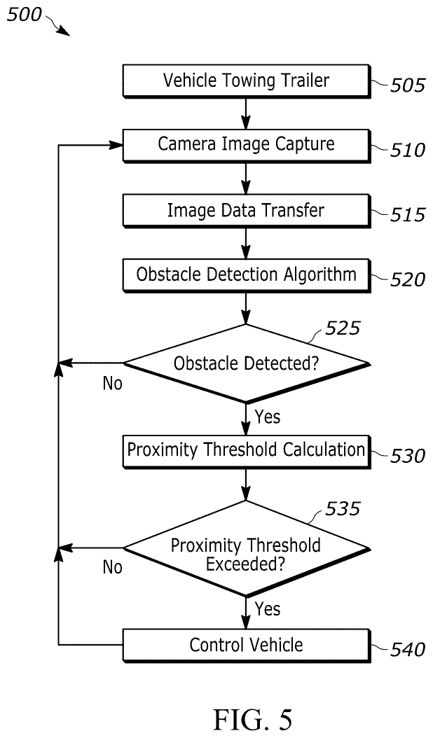

Additionally visible on the image 200 are object data points 230 and background data points 235. The object data points 230 illustrate objects that the obstacle detection algorithm 135 has determined are within a dangerous proximity threshold to the trailer 110. For instance, if an object is determined to have exceeded a dangerous proximity threshold, the obstacle detection algorithm 135 classifies the object as an obstacle 205. However, if the object has not exceeded the dangerous proximity threshold, the algorithm 135 does not classify the object as an obstacle, as illustrated by background data points 235. In some examples, when the algorithm 135 detects an obstacle 205, the controller 115 is instructed to warn the driver of the obstacle 205 proximity or control the vehicle 105 to avoid a collision between the obstacle 205 and the trailer 110. This method is described in greater detail below and illustrated in FIG. 5.

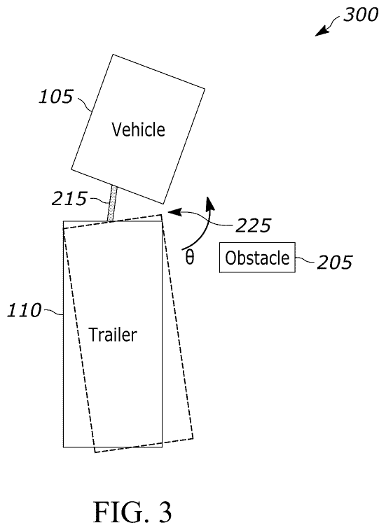

FIG. 3 is a block diagram illustration 300 of a top-down view of the vehicle 105 and trailer 110, according to some aspects. The illustration 300 includes a similar configuration of the vehicle 105, the trailer 110, and the obstacle 205 that is captured in image 200. As the vehicle 105 makes a turn around the detected obstacle 205, the articulation angle Θ (theta) changes. For instance, when the vehicle 105 and the trailer are parallel, such as when the vehicle is diving straight, the articulation angle is approximately 0 degrees. The articulation angle Θ is used by the algorithm 135 to determine the proximity of the object and in determining when an object is an obstacle 205. For example, the algorithm 135 may calculate an instantaneous articulation angle Θ using the known dimensions of the trailer 110 (e.g., trailer length, trailer height, chassis length, and the like) to determine a real-world 3D position of the corner of the trailer. This determination aids the algorithm 135 in calculating the proximity of obstacles 205 to the trailer 110.

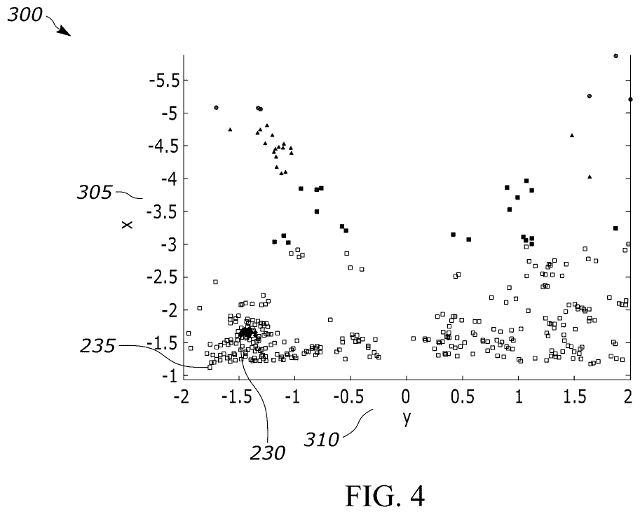

FIG. 4 is a graph 400 illustrating the 2D coordinates of objects detected in a camera image, according to some aspects. The graph 400 is a coordinate plot of the image 200 illustrated in FIG. 2 and includes the same data points of the image 200. The graph 400 includes an X axis 305 and a Y axis 310, along with object data points 230 and background data points 235. For example, along the Y axis 310, a Y coordinate of 0 corresponds with the center line of the image 200. Similarly, the obstacle 205 in image 200 and the object data points 230 are represented on the graph 400. A particular pattern of data points on the graph 400 may indicate the distance between the object and the trailer 110 or that an object is an obstacle 205. For instance, object data points 230 are clustered on the graph 400, where background data points 235 are not. Alternative images captured by the camera 145 generate different graphs containing different data points. As the camera 145 captures images over time, and as the vehicle 105 tows the trailer 110, the data points generate different patterns used by the algorithm 135 in obstacle detection and proximity determination.

FIG. 5 is a flowchart of a process for obstacle detection for trailer turns, according to some aspects. The process 500 begins at step 505, with the vehicle 105 towing the trailer 110. The process continues to step 510, where the camera 145 attached to the vehicle records a wide-angle field of view of the trailer 110. The camera 145 captures multiple image frames and generates image data corresponding with the image scene. At step 515 of the process 500, the image data is transferred from the camera 145 to the controller 115 to be processed by the electronic processor 120. The process continues to step 520, where the electronic processor 120 runs the obstacle detection algorithm 135. Every image captured by the camera 145 is run through the algorithm 135, such that every frame is individually analyzed. The algorithm 135 uses methods such as structure from motion to determine the 3D position of objects captured by the 2D image. Furthermore, the algorithm 135 analyzes the image data and categorizes object data points 230 and background data points 235. The algorithm 135 additionally calculates the 3D position of the corner of the trailer 225 and the instantaneous articulation angle of the trailer. Using these calculated positions, along with the known dimensions of the trailer as previously described and the image data, the algorithm 135 proceeds to determine if any detected objects are obstacles, such as obstacle 205 at step 525 of the process 500. If the algorithm 135 determines that no objects in the image 200 are obstacles 205, the process returns to step 510 where a new camera image is captured. On the other hand, if the algorithm 135 determines that an object is an obstacle 205, the process proceeds to step 530 where the algorithm calculates the proximity of the obstacle 205 to the trailer 110. The process 500 continues to step 535, where the algorithm 135 determines if the detected obstacle 205 has exceeded a dangerous proximity threshold. The dangerous proximity threshold may be, for instance, a range of distance between 5 centimeters to 1 meter. If the object has not exceeded the dangerous proximity threshold, the process returns to step 510 where a new camera image is captured. However, if the dangerous proximity threshold has been exceeded, the process continues to step 540 where the controller 115 is configured to control an aspect of the vehicle. The controller 115 may generate a warning, output by the input/output interface 125, alerting a driver of the vehicle that the trailer 110 and the obstacle 205 are in danger of colliding. In some instances, the controller 115 may control the vehicle to slow down, stop, or otherwise avoid a collision of the trailer 110 with the obstacle 205. In some examples, there are multiple proximity thresholds. For instance, there may be a first proximity threshold, which when exceeded produces an alert for the driver, and a second proximity threshold that is different than the first proximity threshold, which when exceeded causes the controller to control the vehicle. In some instances, the second proximity threshold is a closer distance between the obstacle and the trailer than the first proximity threshold.

Accordingly, various implementations of the systems and methods described herein provide, among other things, techniques for detecting obstacles around a trailer. Other features and advantages of the invention are set forth in the following claims.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

What is claimed is:

1. A system of obstacle detection for a trailer connected to and towed by a vehicle, the system comprising:
a camera positioned at a rear of the vehicle, the camera configured to capture images of the trailer and a scene including an object, the camera further configured to generate image data corresponding to the scene and output the image data;
a controller on the vehicle, the controller including an input/output interface, a memory, and an electronic processor configured to:
receive the image data from the camera,
analyze the object in the scene,
calculate the position of the trailer and the object relative to one another,
determine that the object is an obstacle using an obstacle detection algorithm, and
determine that the obstacle has exceeded a proximity threshold,
wherein in response to the determination that the obstacle has exceeded the proximity threshold, the controller controls the vehicle.

2. The system of claim 1, wherein the electronic processor further analyzes the image data to determine object data points and background data points.

3. The system of claim 2, wherein the electronic processor determines that the object is an obstacle based upon the object data points and determines that the object is not an obstacle based upon the background data points.

4. The system of claim 1, wherein the electronic processor further calculates a 3D position of the trailer, an instantaneous articulation angle of the trailer, and a position of the object relative to the position of the trailer.

5. The system of claim 1, wherein the proximity threshold is a distance of less than 1 meter, and
wherein in response to the determination that the obstacle has exceeded the proximity threshold, the controller stops the vehicle.

6. The system of claim 1, wherein the electronic processor further calculates an instantaneous articulation angle of a plurality of corners of the trailer relative to the object.

7. The system of claim 1, wherein the proximity threshold is a range of distance between the object and the trailer, the range of distance including between 5 centimeters and 1 meter.

8. The system of claim 1, wherein the electronic processor further determines that the obstacle has exceeded a first proximity threshold and a second proximity threshold, the second proximity threshold being a closer proximity between the trailer and the obstacle,
wherein in response to the obstacle exceeding the first proximity threshold, the controller generates an alert, and
wherein in response to the obstacle exceeding the second proximity threshold, the controller controls the vehicle.

9. The system of claim 1, wherein the obstacle detection algorithm includes producing a coordinate plot of the image data including object data points and background data points.

10. A method of obstacle detection for a trailer connected to and towed by a vehicle, the method comprising:
generating, by a camera positioned at a rear of the vehicle, images of the trailer and a scene including an object,
outputting, by the camera, image data corresponding to the scene,
receiving, by an electronic processor, the image data analyzing, by the electronic processor, the object in the scene,
calculating, by the electronic processor, the position of the trailer and the object relative to one another,
determining, by the electronic processor, that the object is an obstacle using an obstacle detection algorithm,
determining, by the electronic processor, that the obstacle has exceeded a proximity threshold, and
wherein response to the determination that the obstacle has exceeded the proximity threshold, controlling, by the electronic processor, the vehicle.

11. The method of claim 10, the method further comprising analyzing, by the electronic processor, the image data to determine object data points and background data points.

12. The method of claim 10, the method further comprising calculating, by the electronic processor, an instantaneous articulation angle of a plurality of corners of the trailer relative to the object.

13. The method of claim 10, the method further comprising calculating, by the electronic processor, a range of distance between the object and the trailer, the range of distance including between 5 centimeters and 1 meter.

14. The method of claim 10, the method further comprising:
determining, by the electronic processor, that the obstacle has exceeded a first proximity threshold and a second proximity threshold, the second proximity threshold being a closer proximity between the trailer and the obstacle,
generating, by the electronic processor, an alert in response to the obstacle exceeding the first proximity threshold, and
controlling, by the electronic processor, the vehicle in response to the obstacle exceeding the second proximity threshold.

15. The method of claim 10, the method further comprising generating by the electronic processor, a coordinate plot of the image data including object data points and background data points.

16. A system of obstacle detection for a trailer connected to and towed by a vehicle, the system comprising:
a camera positioned at a rear of the vehicle, the camera configured to capture images of the trailer and a scene including an object, the camera further configured to generate image data corresponding to the scene and output the image data;
a controller on the vehicle, the controller including an input/output interface, a memory, and an electronic processor configured to:
receive the image data from the camera,
generate object data points and background data points from the image data,
generate a coordinate plot of the image data including object data points and background data points,
calculate a position of a plurality of corners of the trailer using the object data points and background data points,
calculate an instantaneous articulation angle of the plurality of corners of the trailer relative to the object,
calculate a 3D position of the trailer relative to the object using the instantaneous articulation angle,
determine that the object is an obstacle using an obstacle detection algorithm, and
determine that the obstacle has exceeded a first proximity threshold and a second proximity threshold, the second proximity threshold being a closer proximity between the trailer and the obstacle,
wherein in response to the obstacle exceeding the first proximity threshold, the controller generates an alert, and
wherein in response to the obstacle exceeding the second proximity threshold, the controller controls the vehicle.

17. The system of claim 16, wherein the electronic processor determines that the object is an obstacle based upon the object data points and determines that the object is not an obstacle based upon the background data points.

18. The system of claim 16, wherein the electronic processor further calculates the instantaneous articulation angle of the corners of the trailer relative to the object based upon dimensions of the trailer and the position of the corners of the trailer.

19. The system of claim 16, wherein the first proximity threshold is a range of distance between the object and the trailer, the range of distance including between 5 centimeters and 1 meter but greater than the second proximity threshold, and
wherein the second proximity threshold is a range of distance between the object and the trailer, the range of distance including between 5 centimeters and 1 meter but less than the first proximity threshold.

20. The system of claim 16, wherein response to the determination that the obstacle has exceeded the first proximity threshold, the controller generates an alert for a driver of the vehicle, the alert indicating that the trailer and the obstacle are in danger of colliding, and
wherein response to the determination that the obstacle has exceeded the second proximity threshold, the controller stops the vehicle.
